(19) United States
(12) Patent Application Publication
(10) Pub. No.: US 2010/0173144 A1
(43) Pub. Date: Jul. 8, 2010

(54) COMPOSITE MATERIALS ON THE BASIS OF POLYURETHANES WITH IMPROVED ADHESION

(75) Inventors: Markus Schuette, Osnabrueck (DE); Bernd Bruchmann, Freinsheim (DE); Daniel Schoenfelder, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/303,625

(22) PCT Filed: May 30, 2007
(86) PCT No.: PCT/EP07/55253

§ 371 Date: Dec. 5, 2008

(30) Foreign Application Priority Data
Jun. 8, 2006 (EP) 06115161.9

(51) Int. Cl. B32B 5/18; B32B 5/00; B05D 3/00; C09J 175/06; C08L 67/00

(52) U.S. Cl. 428/304.4; 428/339; 427/299; 156/331.7; 524/539

(57) ABSTRACT

The present invention relates to a composite comprising at least one polyurethane and at least one further solid, with the polyurethane comprising a hyperbranched polymer and the thickness of the polyurethane material being 0.1 mm and greater. Furthermore, the invention relates to a process for producing such composites and the use of hyperbranched polymers as constituents of a polyurethane for improving the adhesion between the polyurethane and at least one further solid.

The present invention relates to a composite comprising at least one polyurethane and at least one further solid, with the polyurethane comprising a hyperbranched polymer and the thickness of the polyurethane material being 0.1 mm and greater. Furthermore, the invention relates to a process for producing such composites and the use of hyperbranched polymers as constituents of a polyurethane for improving the adhesion between the polyurethane and at least one further solid.

Further embodiments of the invention may be found in the claims, the description and the examples. It goes without saying that the abovementioned features and the features to be explained below of the subject matter of the invention can be used not only in the respective combination indicated but also in other combinations without going outside the scope of the invention.

Polyurethanes are nowadays frequently used in many applications because of their wide property profile. Polyurethanes can be used both in compact form and in foamed form. The density can vary over a wide range, starting at >1000 g/l for compact systems to about 10 g/l for low-density, foamed bodies. Polyurethanes can, for example, be in the form of thermosets, elastomers, thermoplastic elastomers (TPUs), microcellular elastomers, integral foams, flexible foams, rigid foams or semirigid foams. Further details on this subject may be found in “Kunststoffhandbuch, Volume 7, Polyurethane”, Carl Hanser Verlag, 3rd Edition 1993, Chapters 5 to 8 and also 10-12.

Combining polyurethanes with other materials makes it possible to produce composite materials which further expand the field of use of the material “polyurethane”. Many combinations of polyurethanes with other materials, e.g. with polymers, metals or glass, are known. This enables the positive properties of polyurethanes to be combined with those of other materials. Specific examples of such composites which may be mentioned at this stage are: the composites composed of polyurethane foams and rubber mixtures, leather, thermoplastics or thermoplastic elastomers as are used, for example, for shoe soles, the composites composed of polyurethane foams or polyurethane-based casting elastomers and rubber mixtures as are used, for example, for tires, composite materials composed of polyurethane and other plastics such as polycarbonate/ABS or polypropylene as are used, for example, in automobile interiors and exteriors, composites composed of aluminium sheets and rigid polyurethane foam as are used, for example, as sandwich panels in the refrigeration and construction sectors, glass fiber/polyurethane composites as are used, for example, in laminates or flexible polyurethane foam/textile composites as are used, for example, in upholstery. The adhesion of polyurethane to other materials is generally very good. Nevertheless, the adhesion in specific material combinations in demanding applications cannot always meet requirements. For this reason, improved adhesion of polyurethane to other materials is in many cases desirable for producing composites.

Known methods of improving adhesion usually comprise chemical and/or physical pretreatment of one or both surfaces to be joined. These include corona treatment, flaming, plasma treatment, UV irradiation, sputtering, pickling, electrochemical processes such as anodization or mechanical roughening processes. Furthermore, primers or bonding agents which themselves effect no chemical or morphological change in the substrate surfaces but act as bonding agents are also applied, in combination or separately, to one or both surfaces.

Thus, EP 286 966 describes the plasma treatment of a rubber surface for improving adhesion to a polyurethane foam. The use of a bonding layer for improving adhesion between polyurethane and metal is described, for example, in EP 1516720.

The disadvantage of the known methods is that such processes frequently represent additional production steps and lead to increased expenditure of time and money. In addition, handling solvent-comprising and/or aggressive substances can lead to pollution for human beings and the environment.

Furthermore, it is in many cases desirable to achieve a further improvement in the adhesion of polyurethane to other materials even after chemical and/or physical pretreatment.

WO 05/118677 discloses high-functionality, hyperbranched polyesters or polyaddition or polycondensation products prepared from high-functionality highly branched and hyperbranched polyesters and their use in paints and varnishes, coatings, adhesives, sealants, casting elastomers or foams. According to Examples 29 to 31, the hardness, flexibility and adhesion of surface coatings having a layer thickness of 40 μm to metal sheets can be improved by use of a hyperbranched polymer. WO 05/118677 does not disclose composites having a layer thickness of the polyurethane material of greater than 40 μm.

It was therefore an object of the present invention to provide a composite comprising at least one polyurethane and at least one solid, which composite has improved adhesion between polyurethane and solid without the use of chemical and/or physical pretreatment, wherein the thickness of the polyurethane is 0.1 mm and greater.

Another object of the invention was to provide a composite in which the adhesion between at least one polyurethane and at least one further solid is improved further even after use of chemical and/or physical pretreatment.

It was a further object of the present invention to provide a simple, inexpensive and environmentally friendly process for producing such composites, which process leads to satisfactory adhesion between polyurethane and the at least one solid without additional working steps.

These objects are achieved by a composite comprising at least one polyurethane and at least one further solid, with the polyurethane comprising a hyperbranched polymer and the thickness of the polyurethane being 0.1 mm and greater.

A composite according to the invention is a material which comprises a polyurethane comprising a hyperbranched polymer and a further solid, with the polyurethane comprising a hyperbranched polymer and the further solid being joined to one another by adhesion and the polyurethane having a thickness of greater than 0.1 mm. Composites in which the polyurethane serves merely as adhesive are not comprised. For the present purposes, an adhesive is a material which serves only to join a solid and a further solid by bonding. In contrast to adhesives and surface coatings which serve as decorative surfaces or protective surfaces, both solid and polyurethane in a composite according to the invention contribute to the mechanical properties of the composite.

For the purposes of the invention, the term polyurethane comprises all known polyisocyanate polyaddition products. These comprise, for example, massive polyisocyanate polyaddition products such as thermosets or thermoplastic polyurethanes and foams based on polyisocyanate polyaddition products, e.g. flexible foams, semirigid foams, rigid foams or integral foams, and also polyurethane coatings and binders. Furthermore, polyurethanes for the purposes of the invention include polymer blends comprising polyurethanes and further polymers and also foams comprising these polymer blends.

For the purposes of the invention, a massive polyurethane is a solid which is essentially free of gas inclusions. Further details regarding massive polyurethanes according to the invention may be found in “Kunststoffhandbuch, Volume 7, Polyurethane”, Carl Hanser Verlag, 3rd Edition 1993, Chapter 8. Thermoplastic polyurethanes are massive polyurethanes which display thermoplastic properties. For the present purposes, thermoplastic properties mean that the thermoplastic polyurethane can be melted repeatedly on heating and in this state displays plastic flow. Further details regarding thermoplastic polyurethanes according to the invention may be found in “Kunststoffhandbuch, Volume 7, Polyurethane”, Carl Hanser Verlag, 3rd Edition 1993, Chapter 8.2.

For the purposes of the invention, polyurethane foams are foams in accordance with DIN 7726. Flexible polyurethane foams according to the invention have a compressive stress at 10% deformation or compressive strength in accordance with DIN 53 421/DIN EN ISO 604 of 15 kPa and less, preferably from 1 to 14 kPa and in particular from 4 to 14 kPa. Semirigid polyurethane foams according to the invention have a compressive stress at 10% deformation in accordance with DIN 53 421/DIN EN ISO 604 of from >15 to <80 kPa. Semirigid polyurethane foams and flexible polyurethane foams according to the invention have, in accordance with DIN ISO 4590, a proportion of open cells of preferably greater than 85%, particularly preferably greater than 90%. Further details regarding flexible polyurethane foams and semirigid polyurethane foams according to the invention may be found in “Kunststoffhandbuch, Volume 7, Polyurethane”, Carl Hanser Verlag, 3rd Edition 1993, Chapter 5.

The rigid polyurethane foams according to the invention have a compressive stress at 10% deformation of greater than or equal to 80 kPa, preferably greater than or equal to 150 kPa, particularly preferably greater than or equal to 180 kPa. Furthermore, the rigid polyurethane foam has, in accordance with DIN ISO 4590, a proportion of closed cells of greater than 85%, preferably greater than 90%. Further details regarding the rigid polyurethane foams according to the invention may be found in “Kunststoffhandbuch, Volume 7, Polyurethane”, Carl Hanser Verlag, 3rd Edition 1993, Chapter 6.

For the purposes of the present invention, elastomeric polyurethane foams are polyurethane foams in accordance with DIN 7726 which after brief deformation by 50% of the thickness in accordance with DIN 53 577 have no remaining deformation of more than 2% of their original thickness after 10 minutes. The elastomeric polyurethane foam can be a rigid polyurethane foam, a semirigid polyurethane foam or a flexible polyurethane foam.

Integral polyurethane foams are polyurethane foams in accordance with DIN 7726 having a surface zone which, owing to the shaping process, has a higher density than the core. The overall foam density averaged over the core and the surface zone is preferably above 100 g/l. For the purposes of the invention, integral polyurethane foams, too, can be rigid polyurethane foams, semirigid polyurethane foams or flexible polyurethane foams. Further details regarding integral polyurethane foams according to the invention may be found in “Kunststoffhandbuch, Volume 7, Polyurethane”, Carl Hanser Verlag, 3rd Edition 1993, Chapter 7.

Polyurethane binders comprise binders for agricultural and forestry products, pelletized rubber, rigid polyurethane foam scrap and inorganic products. Such binders are described, for example, in “Kunststoffhandbuch, Volume 7, Polyurethane”, Carl Hanser Verlag, 3rd Edition 1993, Chapter 12.

The polyurethanes according to the invention comprise hyperbranched polymer. A polyurethane according to the invention preferably comprises the hyperbranched polymer in an amount of from 0.001 to 50% by weight, particularly preferably from 0.01 to 30% by weight and in particular from 0.1 to 10% by weight, based on the total weight of the polyurethane and the hyperbranched polymer. The hyperbranched polymer can be present in the form of individual polymer molecules in the polyurethane and form a polymer blend with this or is preferably incorporated by covalent bonding into the polymer matrix of the polyurethane. For the purposes of the invention, a polyurethane according to the invention is a polyurethane comprising hyperbranched polymer.

For the purposes of the invention, hyperbranched polymers are all polymers which have a weight average molecular weight of greater than 500 g/mol and whose main chain is branched and which have a degree of branching (DB) of greater than or equal to 0.05. The hyperbranched polymers preferably have a weight average molecular weight of greater than 800 g/mol, more preferably greater than 1000 g/mol and in particular greater than 1500 g/mol, and a degree of branching of 0.1 and greater. Particular preference is given to a degree of branching of the hyperbranched polymers according to the invention of from 0.2 to 0.99 and in particular from 0.3 to 0.95 and very especially from 0.35 to 0.75. For the definition of the degree of branching, see H. Frey et al., Acta Polym. 1997, 48, 30-35.

Preferred hyperbranched polymers for the purposes of the invention are ones based on ethers, amines, esters, carbonates, amides, urethanes and ureas and also their mixed forms, for example ester-amides, amido-amines, ester-carbonates, urea-urethanes, etc. In particular, hyperbranched polyethers, polyesters, polyester-amides, polycarbonates or polyester-carbonates can be used as hyperbranched polymers. Such polymers and methods of preparing them are described in EP 1141083, in DE 102 11 664, in WO 00/56802, in WO 03/062306, in WO 96/19537, in WO 03/54204, in WO 03/93343, in WO 05/037893, in WO 04/020503, in DE 10 2004 026 904, in WO 99/16810, in WO 05/026234 and in the earlier, as yet unpublished patent application number DE 102005009166.0. Likewise particularly preferred hyperbranched polymers are highly branched and hyperbranched polymers based on polyisobutylene derivatives, as are described in the earlier, as yet unpublished patent application number DE 102005060783.7.

The hyperbranched polymers in the composite are preferably bound to the solid by entanglement of polymer chains or via functional groups at the interface to the solid. This bonding to the solid is preferably via covalent bonds or by interaction of the functional groups with the solid, preferably in the form of interactions of positively and negatively charged groups, electronic donor-acceptor interactions, hydrogen bonds and/or van der Waals interactions.

Solids for the purposes of the invention can be any solids which together with polyurethanes can form a composite. Examples of such solids are further polymers, for example elastomers, thermoplastic elastomers, thermoplastics or thermosets as defined in DIN 7724. It is possible to use the elastomers, for example butadiene rubber (BR), styrene-butadiene rubber (SBR), isoprene rubber (IR), styrene-isoprene-butadiene rubber (SIBR), acrylonitrile-butadiene rubber (NBR), chloroprene rubber (CR), isobutene-isoprene rubber (IIR), natural rubber (NR), both in pure form or in blends or as vulcanized rubber mixtures. Here, the term vulcanized rubber mixtures refers to mixtures of the pure elastomers or elastomer blends or mixtures of elastomers and thermoplastics which have been mixed with vulcanization accelerators and/or crosslinkers based on sulfur or peroxide and vulcanized in accordance with current practice. The elastomers may comprise, if appropriate, commercial fillers such as carbon blacks, silica, chalks, metal oxides, plasticizers and antioxidants and/or ozone protection agents. As thermoplastic elastomers, it is possible to use, for example, thermoplastic polyurethane (TPU), styrene-butadiene-styrene (SBS), styrene-isoprene-styrene (SIS) or comparable polymers. As thermoplastics, it is possible to use, for example, polystyrene, EVA, polyethylene, polypropylene, polycarbonate, styrene-acrylonitrile (SAN), PVC or blends of the thermoplastics mentioned with one another or with the elastomers mentioned, for example blends of polycarbonate and ABS. Further suitable solids are metals such as steel or aluminum, glass, textile materials or mineral materials. The physical form of the solid is likewise not restricted. The solid can, for example, be in the form of sheets, strips, woven fabrics or shaped parts.

In a further embodiment, the solid is present as a filler in the composite of the invention. For the purposes of the present invention, a filler is a solid in particle form which is essentially completely surrounded by the polyurethane. The filler can have any external shape. The filler preferably has a mean particle length or a mean particle diameter of from 1 to 10 000 μm, particularly preferably from 10 to 1000 μm. In the case of elongated fillers, the particle length or particle diameter is the length of the particle along its longest axis.

Fillers used are preferably the customary organic and inorganic fillers, reinforcing materials, weighting agents, agents for improving the abrasion behavior, etc., known per se. Specific examples are: inorganic fillers such as siliceous minerals, for example sheet silicates such as antigorite, serpentine, hornblendes, amphiboles, chrysotile, talc; metal oxides such as kaolin, aluminum oxides, titanium oxides and iron oxides, metal salts such as chalk, barite and inorganic pigments such as cadmium sulfide, zinc sulfide and also glass, etc. Preference is given to using kaolin (china clay), aluminum silicate and coprecipitates of barium sulfate and aluminum silicate and also natural and synthetic fibrous minerals such as wollastonite, metal fibers and in particular glass fibers of various lengths which may, if appropriate, be coated with a size. Examples of inorganic fillers are: carbon black, melamine, rosin, cyclopentadienyl resins and graft polymers and also cellulose fibers, polyamide, polyacrylonitrile, polyurethane, polyester fibers based on aromatic and/or aliphatic dicarboxylic esters and in particular carbon fibers.

The inorganic and organic fillers can be used individually or as mixtures and are preferably comprised in the composite in amounts of from 0.5 to 50% by weight, particularly preferably from 1 to 40% by weight, based on the weight of the polyurethane and the filler.

The thickness of the polyurethane comprising hyperbranched polymer in the composite of the invention is 0.1 mm and greater, particularly preferably 1 mm and greater and in particular 5 mm and greater. The thickness is preferably not more than one meter. For the present purposes, the thickness of the polyurethane comprising hyperbranched polymer in the composite after application over an area is the height of the polyurethane layer comprising hyperbranched polymer perpendicular to the surface of the solid. In cases in which the solid is present as filler, the thickness of the polyurethane comprises filler and polyurethane comprising hyperbranched polymer.

The composites of the invention are produced, in a first embodiment, by mixing (a) organic and/or modified polyisocyanates with (b) at least one relatively high molecular weight compound having at least two reactive hydrogen atoms, (c) hyperbranched polymers, (d) if appropriate low molecular weight chain extenders and/or crosslinkers, (e) catalysts, (f) if appropriate blowing agents and (g) if appropriate other additives to form a reaction mixture. The reaction mixture is subsequently applied in the unreacted state to the solid. The degree of reaction on application is preferably less than 90%, particularly preferably less than 75% and in particular less than 50%.

The polyisocyanate component (a) used for producing the composites of the invention comprise all polyisocyanates known for producing polyurethane. These comprise the aliphatic, cycloaliphatic and aromatic divalent or polyvalent isocyanates known from the prior art and also any mixtures thereof. Examples are diphenylmethane 2,2′-, 2,4′- and 4,4′-diisocyanate, mixtures of monomeric diphenylmethane diisocyanates, and homologues of diphenylmethane diisocyanate having a larger number of rings (polymeric MDI), isophorone diisocyanate (IPDI) or its oligomers, tolylene 2,4- or 2,6-diisocyanate (TDI) or mixtures thereof, tetramethylene diisocyanate or its oligomers, hexamethylene diisocyanate (HDI) or its oligomers, naphthylene diisocyanate (NDI) or mixtures thereof.

Preference is given to using 4,4′-MDI and/or HDI. The particularly preferred 4,4′-MDI can comprise small amounts up to about 10% by weight of uretdione-, allophanate- or uretonimine-modified polyisocyanates. Further possible isocyanates are indicated, for example, in “Kunststoffhandbuch, Volume 7, Polyurethane”, Carl Hanser Verlag, 3rd Edition 1993, Chapters 3.2 and 3.3.2.

The polyisocyanate component (a) can be used in the form of polyisocyanate prepolymers. These polyisocyanate prepolymers can be obtained by reacting an excess of polyisocyanates as described above (constituent (a-1)) with polyols (constituent (a-2)), for example at temperatures of from 30 to 100° C., preferably about 80° C., to form the prepolymer.

Polyols (a-2) are known to those skilled in the art and are described, for example, in “Kunststoffhandbuch, 7, Polyurethane”, Carl Hanser Verlag, 3rd Edition 1993, Chapter 3.1. Thus, it is also possible, for example, to use the polyols described below under (b) as polyols.

In one embodiment, the prepolymer can also be prepared using a hyperbranched polymer having hydrogen atoms which are reactive toward isocyanates as constituent (a2).

If appropriate, chain extenders (a-3) can additionally be added to the reaction to form the polyisocyanate prepolymer. Suitable chain extenders (a-3) for the prepolymer are dihydric or trihydric alcohols, for example dipropylene glycol and/or tripropylene glycol, or adducts of dipropylene glycol and/or tripropylene glycol with alkylene oxides, preferably propylene oxide.

As relatively high molecular weight compounds (b) having at least two reactive hydrogen atoms, it is possible to use all relatively high molecular weight compounds (b) having at least two reactive hydrogen atoms which are known for polyurethane production, for example ones having a functionality of from 2 to 8 and a molecular weight of from 400 to 12 000. Thus, it is possible to use, for example, polyether polyamines and/or polyols selected from the group consisting of polyether polyols, polyester polyols or mixtures thereof.

Polyetherols are prepared, for example, from epoxides such as propylene oxide and/or ethylene oxide or from tetrahydrofuran using hydrogen-active starter compounds such as aliphatic alcohols, phenols, amines, carboxylic acids, water or compounds based on natural products, e.g. sucrose, sorbitol or mannitol and a catalyst. Mention may here be made of basic catalysts or double metal cyanide catalysts as described, for example, in PCT/EP2005/010124, EP 90444 or WO 05/090440.

Polyesterols are prepared, for example, from alkanedicarboxylic acids and polyhydric alcohols, polythioether polyols, polyesteramides, hydroxyl-comprising polyacetals and/or hydroxyl-comprising aliphatic polycarbonates, preferably in the presence of an esterification catalyst. Further possible polyols are indicated, for example, in “Kunststoffhandbuch, Volume 7, Polyurethane”, Carl Hanser Verlag, 3rd Edition 1993, Chapter 3.1.

For the purposes of the invention, hyperbranched polymers (c) used are any polymers which have a weight average molecular weight of greater than 500 g/mol and whose main chain is branched and which have a degree of branching (DB) of greater than or equal to 0.05. These are preferably hyperbranched polymers having a weight average molecular weight of greater than 800 g/mol, preferably greater than 1000 g/mol and in particular greater than 1500 g/mol, and a degree of branching of 0.1 and greater. The degree of branching of the hyperbranched polymers according to the invention is particularly preferably from 0.2 of 0.99 and in particular from 0.3 to 0.95 and very especially from 0.35 to 0.75.

Preferred hyperbranched polymers (c) are hyperbranched polymers based on ethers, amines, esters, carbonates, amides, urethanes and ureas and also their mixed forms, for example ether-amines, ester-amides, amido-amines, ester-carbonates, urea-urethanes, etc. In particular, it is possible to use hyperbranched polyethers, polyether-amines, polyesters, polyester-amides, polycarbonates or polyester-carbonates as hyperbranched polymers. Such polymers and methods of preparing them are described in EP 1141083, in DE 102 11 664, in WO 00/56802, in WO 03/062306, in WO 96/19537, in WO 03/54204, in WO 03/93343, in WO 05/037893, in WO 04/020503, in DE 10 2004 026 904, in WO 99/16810, in WO 05/026234 and in our own as yet unpublished patent application number DE 102005009166.0. Further particularly preferred hyperbranched polymers are highly branched and hyperbranched polymers based on polyisobutylene derivatives, as described in our own, as yet unpublished patent application number DE 102005060783.7.

In one embodiment, the hyperbranched polymers according to the invention have different functional groups. These functional groups are preferably able to react with isocyanates and/or with reactive groups of the solid or else interact with the solid.

Functional groups which are reactive toward isocyanates are, for example, hydroxyl, amino, mercapto, epoxy, carboxyl or acid anhydride groups, preferably hydroxyl, amino, mercapto or acid anhydride groups.

Functional groups which can react with the reactive groups of the solid are, for example, hydroxyl, amino, mercapto, epoxy, carboxyl or acid anhydride groups, carbonyl groups, olefinic double bonds, triple bonds, activated double bonds, as are known, for example, as (meth)acrylate groups or as groups comprising maleic or fumaric acid or derivatives thereof.

The functional groups which can interact with the solid are units which do not react covalently with the solid but undergo interactions, for example via positively or negatively charged groups, via electronic donor or acceptor bonds, via hydrogen bonds or via van der Waals bonds. Examples are charged groups such as ammonium, phosphonium, guanidinium, carboxylate, sulfate, sulfinate or sulfonate groups.

Units which form hydrogen bonds or donor and acceptor bonds comprise all donor-acceptor pairs known in supramolecular chemistry. They can be formed by, for example, hydroxyl, amino, mercapto, epoxy, carboxyl or acid anhydride groups, urea groups, urethane groups, carbonyl groups, ether groups, olefinic double bonds, conjugated double bonds, triple bonds, activated double bonds, for example (meth)acrylate groups or groups comprising maleic or fumaric acid or derivatives thereof.

Elements producing van der Waals bonds can be, for example, linear or branched alkyl, alkenyl or alkynyl radicals having a chain length of C₁-C₁₂₀ or aromatic systems having 1-10 ring systems which may also be substituted by heteroatoms such as nitrogen, phosphorus, oxygen or sulfur. Further possibilities are linear or branched polyether elements based on ethylene oxide, propylene oxide, butylene oxide, styrene oxide or mixtures thereof and also polyethers based on tetrahydrofuran or butanediol.

In a preferred embodiment, the polymers have both groups which are reactive toward isocyanate and groups which react or interact with the solid, for example the ester, ether, amide and/or carbonate structures obtained by linkage of the monomers and also hydroxyl groups, carboxyl groups, amino groups, acid anhydride groups, (meth)acrylic double bonds, maleic double bonds and/or long-chain alkyl radicals.

The hyperbranched polymers (c) according to the invention generally have an acid number in accordance with DIN 53240, part 2, of from 0 to 50 mg KOH/g, preferably from 1 to 35 mg KOH/g and particularly preferably from 2 to 20 mg KOH/g and in particular from 2 to 10 mg KOH/g.

Furthermore, the hyperbranched polymers (c) generally have a hydroxyl number in accordance with DIN 53240, part 2, of from 0 to 500 mg KOH/g, preferably from 10 to 500 mg KOH/g and particularly preferably from 10 to 400 mg KOH/g.

The hyperbranched polymers (c) according to the invention also generally have a glass transition temperature (measured by the ASTM method D3418-03 by means of DSC) of from −60 to 100° C., preferably from −40 to 80° C.

The high-functionality, hyperbranched polymers (c) according to the invention are preferably amphiphilic polymers. The amphiphilicity is preferably obtained by introduction of hydrophobic radicals into a hydrophilic, hyperbranched polymer, for example a hyperbranched polymer based on a polyester. Such hydrophobic radicals preferably have more than 6, particularly preferably more than 8, and less than 100 and in particular more than 10 and less than 50 carbon atoms.

The hydrophobicization can be effected in the esterification by, for example, complete or partial replacement of dicarboxylic and/or polycarboxylic acids or diols and/or polyols by monocarboxylic, dicarboxylic and/or polycarboxylic acids comprising such a hydrophobic radical or monools, diols and/or polyols comprising such a hydrophobic radical. Examples of such monocarboxylic, dicarboxylic or polycarboxylic acids comprising a hydrophobic radical are aliphatic carboxylic acids such as octanoic acid, decanoic acid, dodecanoic acid, tetradecanoic acid, fatty acids such as stearic acid, oleic acid, lauric acid, palmitic acid, linoleic acid, linolenic acid, aromatic carboxylic acids such as phthalic acid, isophthalic acid, terephthalic acid, trimellitic acid, cycloaliphatic carboxylic acids such as cyclohexanedicarboxylic acid, dicarboxylic acids such as octanedioic acid, decanedioic acid, dodecanedioic acid, tetradecanedioic acid and dimeric fatty acids. Examples of monools, diols or polyols comprising a hydrophobic radical are aliphatic alcohols such as the isomers of octanol, decanol, dodecanol, tetradecanol, fatty alcohols such as stearyl alcohol, oleyl alcohol, unsaturated alcohols such as allyl alcohol, crotyl alcohol, aromatic alcohols such as benzyl alcohol, cycloaliphatic alcohols, such as cyclohexanol and glyceryl monoesters of fatty acids, for example glyceryl monostearate, glyceryl monooleate, glyceryl monopalmitate.

The hyperbranched polymers (c) generally have an HLB of from 1 to 20, preferably from 3 to 20 and particularly preferably from 4 to 20. If alkoxylated alcohols are used for producing the high-functionality, highly branched and hyperbranched polymers (c) according to the invention, the HLB is preferably from 5 to 8.

The HLB is a measure of the proportions of hydrophilic and lipophilic parts of a chemical compound. The determination of the HLB is described, for example, in W. C. Griffin, Journal of the Society of Cosmetic Chemists, 1949, 1, 311 and W. C. Griffin, Journal of the Society of Cosmetic Chemists, 1954, 5, 249.

In the case of polyesters and hydrophobicized polyesters, the HLB represents the ratio of the number of ethylene oxide groups multiplied by 100 to the number of carbon atoms in the lipophilic part of the molecule and is calculated by the method of C. D. Moore, M. Bell, SPC Soap, Perfum. Cosmet. 1956, 29, 893, as follows:

HLB=(number of ethylene oxide groups)*100/(number of carbon atoms in the lipophilic part of the molecule)

In a particularly preferred embodiment, a hyperbranched polyester d1) which is obtained by esterification of α,β-unsaturated carboxylic acids or derivatives thereof with a polyfunctional alcohol to form the polyester is used as hyperbranched polymer (c). As α,β-unsaturated carboxylic acids or derivatives thereof, preference is given to using dicarboxylic acids or derivatives thereof, with the double bond being adjacent to each of the two carboxyl groups in a particularly preferred embodiment. Such particularly preferred a,(3-unsaturated carboxylic acids or derivatives thereof are, for example, maleic anhydride, maleyl dichloride, fumaryl dichloride, fumaric acid, itaconic acid, itaconyl dichloride and/or maleic acid, preferably maleic acid, maleic anhydride or maleyl dichloride, particularly preferably maleic anhydride. The α,β-unsaturated carboxylic acids or derivatives thereof can be used either alone, as a mixture with one another or together with further carboxylic acids, preferably dicarboxylic or polycarboxylic acids or derivatives thereof, particularly preferably dicarboxylic acids or derivatives thereof, for example adipic acid. In the following, the expression “α,β-unsaturated carboxylic acids or derivatives thereof” also encompasses mixtures comprising two or more α,β-unsaturated carboxylic acids or mixtures comprising one or more a,13-unsaturated carboxylic acids and further carboxylic acids.

Polyesters (c1) based on maleic anhydride are described, for example, in DE 102004026904, WO 2005037893. As polyfunctional alcohol, preference is given to using a polyetherol or polyesterol, for example as described under (b), or mixtures of various polyols. The total mixture of alcohols used has a mean functionality of from 2.1 to 10, preferably from 2.2 to 8 and particularly preferably from 2.2 to 4.

In the reaction of the α,β-unsaturated carboxylic acids or derivatives thereof with the polyhydric alcohol, the ratio of the reactants is preferably selected so that the molar ratio of molecules having groups which are reactive toward acid groups or derivatives thereof to molecules having acid groups or derivatives thereof is from 2:1 to 1:2, particularly preferably from 1.5:1 to 1:2, very particularly preferably from 0.9:1 to 1:1.5 and in particular 1:1. The reaction is carried out under reaction conditions under which acid groups or derivatives thereof and groups which are reactive toward acid groups or derivatives thereof react with one another.

The particularly preferred hyperbranched polyesters are prepared by reacting the α,β-unsaturated carboxylic acids or derivatives thereof with the polyfunctional alcohol, preferably at temperatures of from 80 to 200° C., particularly preferably from 100 to 180° C. The preparation of the particularly preferred hyperbranched polyesters can be carried out in bulk or in solution. Suitable solvents are, for example, hydrocarbons such as paraffins or aromatics. Particularly useful paraffins are n-heptane, cyclohexane and methylcyclohexane. Particularly useful aromatics are toluene, ortho-xylene, meta-xylene, para-xylene, xylene as an isomer mixture, ethylbenzene, chlorobenzene and ortho- and meta-dichlorobenzene. Ethers such as dioxane or tetrahydrofuran and ketones such as methyl ethyl ketone and methyl isobutyl ketone are also suitable as solvents.

The pressure conditions in the preparation of the particularly preferred polyesters (c1) by reacting α,β-unsaturated carboxylic acids or derivatives thereof with the polyfunctional alcohol are not critical per se. The reaction can be carried out under a significantly reduced pressure, for example from 1 to 500 mbar. The process for the preparation can also be carried out at pressures above 500 mbar. A reaction under atmospheric pressure is also possible, but a reaction at slightly superatmospheric pressure, for example up to 1200 mbar, is likewise possible. The reaction can also be carried out under significantly superatmospheric pressure, for example at pressures up to 10 bar. For reasons of simplicity, the reaction is preferably carried out at atmospheric pressure. The reaction under reduced pressures is likewise preferred. The reaction time is usually from 10 minutes to 48 hours, preferably from 30 minutes to 24 hours and particularly preferably from 1 to 12 hours.

The particularly preferred hyperbranched polyesters (c1) obtained have a weight average molecular weight determined by means of PMMA-calibrated GPC of from 1000 to 500 000 g/mol, preferably from 2000 to 200 000 g/mol, particularly preferably from 3000 to 120 000 g/mol.

In a further particularly preferred embodiment, a hydrophobicized hyperbranched polyester (c2) is used as hyperbranched polymer. Here, the hydrophobicized hyperbranched polyester (c2) is prepared by a method analogous to the preparation of the hyperbranched polyester (c1) with all or part of the α,β-unsaturated carboxylic acids used or derivatives thereof being hydrophobicized. As α,β-unsaturated carboxylic acids, preference is given to using maleic acid, maleic anhydride and fumaric acid, particularly preferably maleic anhydride. This hydrophobicization can be carried out after or preferably before the reaction with the alcohol to form the polyester. As hydrophobicizing agents, preference is given to using hydrophobic compounds comprising at least one C—C double bond, e.g. linear or branched polyisobutylene, polybutadiene, polyisoprene and unsaturated fatty acids or derivatives thereof. The reaction with the hydrophobicizing agents is carried out by methods known to those skilled in the art, with the hydrophobicizing agent being added onto the double bond in the vicinity of the carboxyl group, as described, for example, in the German first publications DE 195 19 042 and DE 43 19 671. Such particularly preferred hydrophobicized hyperbranched polyesters (c2) and their preparation are described, for example, in the earlier patent application number DE 102005060783.7. Preference is given to starting up from polyisobutylene having a molecular weight of from 100 to 10 000 g/mol, particularly preferably from 500 to 5000 g/mol and in particular from 550 to 2000 g/mol. Hyperbranched polyesters (c2) which comprise an adduct of reactive polyisobutylene and maleic anhydride, known as polyisobutylenesuccinic acid (PIBSA), or alkenylsuccinic acid are particularly preferred as hydrophobicized, hyperbranched polyester (c2).

In a further particularly preferred embodiment, mixtures comprising a hyperbranched polyester (c1) and a hydrophobicized hyperbranched polyester (c2) are used as hyperbranched polymer (c).

If the component (b) used for the preparation of the isocyanate prepolymer according to the invention comprises more than 50% by weight, based on the total weight of the component (b), of a polyesterol, the content of hyperbranched polyester (c1) is preferably greater than 5% by weight, particularly preferably greater than 20% by weight, very particularly preferably greater than 50% by weight and in particular 100% by weight, based on the total weight of the hyperbranched polymer (c).

The hyperbranched polymers according to the invention are preferably comprised in the polyurethane in an amount of from 0.001 to 50% by weight, particularly preferably from 0.01 to 30% by weight and in particular from 0.1 to 10% by weight, based on the total weight of the polyurethane. These amounts also comprise hyperbranched polymer which has previously been used for preparing polyisocyanate prepolymers. It is possible for, if appropriate, the total content of hyperbranched polymer to be used for preparing polyisocyanate prepolymers.

It is possible to use a chain extender (d) in the production of a composite according to the invention. However, the chain extender (d) can also be omitted. However, the addition of chain extenders, crosslinkers, or, if appropriate, mixtures thereof can prove to be advantageous for modifying the mechanical properties, e.g. the hardness.

If low molecular weight chain extenders and/or crosslinkers (d) are used, it is possible to use the chain extenders known for the production of polyurethanes. These are preferably low molecular weight compounds which are reactive toward isocyanates, for example glycerol, trimethylolpropane, glycol and diamines. Further possible low molecular weight chain extenders and/or crosslinkers are indicated, for example, in “Kunststoffhandbuch, Volume 7, Polyurethane”, Carl Hanser Verlag, 3rd Edition 1993, Chapters 3.2 and 3.3.2.

The chain extenders and/or crosslinkers (d) mentioned can be used individually or as mixtures of identical or different types of compounds.

As catalysts (e), it is possible to use all catalysts customary for polyurethane production. Such catalysts are described, for example, in “Kunststoffhandbuch, Volume 7, Polyurethane”, Carl Hanser Verlag, 3rd Edition 1993, Chapter 3.4.1. Possibilities are, for example, organic metal compounds, preferably organic tin compounds such as tin(II) salts of organic carboxylic acids, e.g. tin(II) acetate, tin(II) octoate, tin(II) ethyl-hexanoate and tin(II) laurate, and the dialkyltin(IV) salts of organic carboxylic acids, e.g. dibutyltin diacetate, dibutyltin dilaurate, dibutyltin maleate and dioctyltin diacetate, and also bismuth carboxylates such as bismuth(III) neodecanoate, bismuth 2-ethyl-hexanoate and bismuth octoate, or mixtures. Further possible catalysts are strongly basic amine catalysts. Examples are amidines such as 2,3-dimethyl-3,4,5,6-tetrahydro-pyrimidine, tertiary amines such as triethylamine, tributylamine, dimethylbenzylamine, N-methylmorpholine, N-ethylmorpholine, N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, bis(dimethylaminoethyl)ether, bis(dimethylaminopropyl)urea, dimethylpiperazine, 1,2-dimethylimidazole, 1-azabicyclo[3.3.0]octane and preferably 1,4-diazabicyclo[2.2.2]octane and alkanolamine compounds such as triethanolamine, triisopropanolamine, N-methyl-diethanolamine and N-ethyldiethanolamine and dimethylethanolamine. The catalysts can be used individually or as mixtures. If appropriate, mixtures of metal catalysts and basic amine catalysts are used as catalysts (e).

Particularly when using a relatively large excess of polyisocyanate, further possible catalysts are: tris(dialkylaminoalkyl)-s-hexahydrotriazines, preferably tris(N,N-dimethyl-aminopropyl)-s-hexahydrotriazine, tetraalkylammonium hydroxides such as tetra-methylammonium hydroxide, alkali metal hydroxides such as sodium hydroxide and alkali metal alkoxides such as sodium methoxide and potassium propoxide and also alkali metal salts of long-chain fatty acids having from 10 to 20 carbon atoms and, if appropriate, lateral hydroxyl groups.

The catalysts (e) can be used, for example, in a concentration of from 0.001 to 5% by weight, in particular from 0.05 to 2% by weight, as catalyst or catalyst combination, based on the weight of component (b).

Furthermore, blowing agents (f) are used in the production of composites according to the invention if the polyurethane is to be present as polyurethane foam. Here, it is possible to use all blowing agents known for the production of polyurethanes. These can comprise chemical and/or physical blowing agents. Such blowing agents are described, for example, in “Kunststoffhandbuch, Volume 7, Polyurethane”, Carl Hanser Verlag, 3rd Edition 1993, Chapter 3.4.5. For the purposes of the present invention, chemical blowing agents are compounds which form gaseous products by reaction with isocyanate. Examples of such blowing agents are water and carboxylic acids. Physical blowing agents are compounds which are dissolved or emulsified in the starting materials for polyurethane production and vaporize under the conditions of polyurethane formation. They are, for example, hydrocarbons, halogenated hydrocarbons and other compounds, for example perfluorinated alkanes such as perfluorohexane, chlorofluorocarbons and ethers, esters, ketones and/or acetals.

As further blowing agent, it is also possible to add, in one embodiment, microspheres which comprise physical blowing agent.

Furthermore, auxiliaries and/or additives (g) can additionally be used in the production of composites according to the invention. Here, it is possible to use all auxiliaries and additives known for the production of polyurethanes. Examples of suitable auxiliaries and additives are surface-active substances, foam stabilizers, cell regulators, mold release agents, fillers, dyes, pigments, flame retardants, hydrolysis inhibitors, fungistatic and bacteriostatic substances. Such substances are described, for example, in “Kunststoffhandbuch, Volume 7, Polyurethane”, Carl Hanser Verlag, 3rd Edition 1993, Chapters 3.4.4 and 3.4.6 to 3.4.11.

In the production of the composite of the invention, the organic polyisocyanates (a), the relatively high molecular weight compounds having at least two reactive hydrogen atoms (b), hyperbranched polymers (c) and, if appropriate, the chain extenders and/or crosslinkers (d) are generally reacted in such amounts that the equivalence ratio of NCO groups of the polyisocyanates (a) to the sum of the reactive hydrogen atoms of the components (b), (c) and, if appropriate, (d) and (f) is 0.85-1.25:1, preferably 0.90-1.15:1. If the cellular polymers comprise at least some bound isocyanurate groups, it is usual to use a ratio of NCO groups of the polyisocyanates (a) to the sum of the reactive hydrogen atoms of the components (b), (c) and, if appropriate, (d) and (f) of 1.5-20:1, preferably 1.5-8:1. A ratio of 1:1 corresponds to an isocyanate index of 100.

The specific starting substances (a) to (f) for producing composites according to the invention differ only slightly both quantitatively and qualitatively when a thermoplastic polyurethane, a flexible foam, a semirigid foam, a rigid foam or an integral foam is to be produced as polyurethane according to the invention. Thus, for example, no blowing agents are used for producing massive polyurethanes. Furthermore, it is possible to vary, for example, the elasticity and hardness of the polyurethane according to the invention via the functionality and the chain length of the relatively high molecular weight compound having at least two reactive hydrogen atoms. Such modifiers are known to those skilled in the art.

The starting materials for producing a massive polyurethane are described, for example, in EP 0989146 or EP 1460094, the starting materials for producing a flexible foam are described in PCT/EP2005/010124 and EP 1529792, the starting materials for producing a semirigid foam are described in “Kunststoffhandbuch, Volume 7, Polyurethane”, Carl Hanser Verlag, 3rd Edition 1993, Chapter 5.4, the starting materials for producing a rigid foam are described in PCT/EP2005/010955 and the starting materials for producing an integral foam are described in EP 364854, U.S. Pat. No. 5,506,275 or EP 897402. The hyperbranched polymer (c) is then in each case added to the starting materials described in these documents, with the mixing ratios of the other starting materials relative to one another preferably not changing in each case. With regard to specific starting materials for producing coatings and binders, reference may likewise be made to “Kunststoffhandbuch, Volume 7, Polyurethane”, Carl Hanser Verlag, 3rd Edition 1993, Chapters 10 and 12.

As an example of a process for producing a composite according to the first embodiment, mention may be made of the “double belt process” which is preferably employed in the production of composites comprising rigid polyurethane foam. Here, an upper covering layer and a lower covering layer, for example of metal, aluminum foil or paper, is rolled off from a roll. The reaction mixture comprising the components (a) to (c), (e), (f) and, if appropriate, (g) is mixed, for example in a high-pressure mixing head, applied to the lower covering layer and cured between the upper and lower covering layers in the double belt. The elements are subsequently cut to the desired length.

In the production of composites based on elastomeric polyurethane foams according to the first embodiment, the solid is preferably placed in a mold and the reaction mixture obtainable by mixing the components (a) to (f) and, if appropriate, (g) is injected into the mold. This is advantageously achieved by means of the “one shot process”, for example with the aid of the reaction injection molding technique, high-pressure technique or low-pressure technique in open or closed molds, for example metallic molds, e.g. of aluminum, cast iron or steel, which comprise the solid.

Mixing of the starting components of the polyurethane foam (a) to (f) and, if appropriate, (g) is carried out at a temperature of from 15 to 90° C., preferably from 20 to 50° C. The mixture is introduced into the open mold or, if appropriate under superatmospheric pressure, into the closed mold comprising the solid. Mixing can, for example, be carried out mechanically by means of a stirrer or a stirring screw or under superatmospheric pressure in the countercurrent injection process. The mold temperature is advantageously from 20 to 90° C., preferably from 30 to 60° C. and in particular from 45 to 50° C.

The moldings having a compacted surface zone and a cellular core are, according to the first embodiment, produced in a closed mold comprising the solid with compaction at a degree of compaction of from 1.5 to 8.5, preferably from 2 to 6.

The cellular polyurethanes comprising hyperbranched polymer in the composite generally have densities of from about 0.35 to 1.2 g/cm³, preferably from 0.45 to 0.85 g/cm³, with the density of filler-comprising products being able to reach higher values, e.g. up to 1.4 g/cm³ and more.

Furthermore, according to the first embodiment of the process of the invention, it is possible to produce composite materials which comprise flexible, semirigid and rigid polyurethane foams and corresponding integral polyurethane foams which ,comprise hyperbranched polymer and have a density of from 0.02 to 0.45 g/cm³. The overall densities of the semirigid foams and the integral polyurethane foams comprising hyperbranched polymer in the composites of the invention are preferably from 0.2 to 0.9 g/cm³, in particular from 0.35 to 0.8 g/cm³.

If the solid is to be enclosed entirely or partly by the polyurethane, the solid is, in a second embodiment of the process for producing a composite according to the invention, mixed, for example as filler, with the components (a) to (g). The reaction mixture comprising the solid is subsequently allowed to react fully.

In a third embodiment, thermoplastic polyurethane obtainable by mixing the components (a) to (e) and, if appropriate, (g) using exclusively diisocyanates as organic and/or modified polyisocyanates (a), exclusively relatively high molecular weight compounds having precisely two reactive hydrogen atoms as relatively high molecular weight compound having at least two reactive hydrogen atoms (b) and exclusively chain extenders and/or crosslinkers having precisely two reactive hydrogen atoms as chain extenders and/or crosslinkers (d), melting the mixture and applying it in the molten state to the solid with which the composite is to be formed. Here, the term “applying” refers to any type of application, for example by placing the solid in a closed mold and injecting the thermoplastic polyurethane.

If the solid is to be entirely or partly enclosed by thermoplastic polyurethane comprising hyperbranched polymer, it is possible, according to a fourth embodiment of the process for producing a composite according to the invention, to melt the thermoplastic polyurethane and mix it with the solid.

In all embodiments of the production of a composite according to the invention, the actual production of polyurethanes comprising hyperbranched polymer is carried out by methods analogous to known processes for producing polyurethane, with a hyperbranched polymer being comprised as additional constituent in the reaction mixture. Polyurethanes comprising hyperbranched polymer can be produced by mixing (a) organic and/or modified polyisocyanates with (b) at least one relatively high molecular weight compound having at least two reactive hydrogen atoms, (c) hyperbranched polymers, (d) if appropriate low molecular weight chain extenders and/or crosslinkers, (e) catalysts, (f) if appropriate blowing agents and (g) if appropriate other additives to form a reaction mixture and allowing this reaction mixture to react fully.

In the case of thermoplastic polyurethane, the thermoplastic polyurethane comprising hyperbranched polymer can also be obtained by homogenizing a thermoplastic polyurethane with the hyperbranched polymer, for example in an extruder.

Examples of composites according to the invention and possible uses for these are mentioned below, but these do not constitute a restriction. Thus, composites according to the invention can be used, for example, in the field of shoe soles. In this case, preference is given to using composites comprising polyurethane foams comprising a hyperbranched polymer together with elastomers, elastomer bonds, rubber mixtures or leather. In the case of composites comprising polyurethane foams or casting systems together with elastomers, elastomer blends or rubber mixtures, these can be used, for example, as tire treads in the field of automobiles, bicycles or in-line skates. In the case of composites comprising polyurethane foams together with polypropylene or polycarbonate/acrylonitrile-butadiene-styrene, these can be used, for example, in automobile interiors, for example as dashboards. In the case of composites comprising rigid polyurethane foams and aluminum sheets, these can be used, for example, as sandwich panels for the cladding of buildings or as insulation elements in refrigerators.

In the case of composites comprising glass fiber-polyurethane elastomer, these can be used, for example, in laminates for RIM components in automobile exteriors or in the case of flexible foam-textile composites, these can be used, for example, for upholstered furniture or seats. In all processes according to the invention, the solid can be used without pretreatment. It is likewise possible to employ known methods of improving the adhesion, comprising, for example, chemical and/or physical pretreatment. Such treatments include corona treatment, flaming, plasma treatment, UV irradiation, sputtering, pickling, electrochemical processes such as anodization or mechanical roughening processes.

In addition, primers or bonding agents which themselves do not cause any chemical or morphological change in the substrate surfaces but act as bonding agents can also be applied to the solid, either in combination or separately. Such methods of improving adhesion are generally known and are described, for example, in Pocius, Adhesion and technology, Munich, Carl-Hanser Verlag, 2002.

An advantage of a composite according to the invention is the improved adhesion between polyurethane and solid. This can be achieved without use of additional steps and/or methods of improving the adhesion which are complicated, hazardous to health or aggressive.

The following examples illustrate the invention.

### EXAMPLES

Preparation of a Hyperbranched Polymer

### Example 1

Synthesis of a hyperbranched polyester comprising hydroxyl groups, carboxyl groups and maleic double bonds as functional elements.

1149.4 g of trimethylolpropane, 420 g of maleic anhydride, 625.8 g of adipic acid and 0.08 g of dibutyltin dilaurate were weighed together into a flask equipped with stirrer, internal thermometer and descending condenser with vacuum connection and firstly heated slowly under atmospheric pressure without stirring until the mixture melted at about 80° C. The mixture was then heated to 140° C. while stirring. The reaction mixture was stirred at this temperature for 2 hours, with 99 g of water distilling off. The mixture was then cooled somewhat and a further 229.9 g of trimethylolpropane were added. The mixture was subsequently heated to 140° C. again and the pressure was slowly reduced stepwise to 50 mbar. The temperature was subsequently increased to 160° C.

After 3 hours at 160° C. and a pressure of 40 mbar, the acid number was about 30 mg KOH/g. The temperature was increased to 180° C. After a further 3.5 hours and a final vacuum of 30 mbar, an acid number of <10 mg KOH/g had been reached and the reaction mixture was cooled.

Analysis:

Acid number: 9 mg KOH/g

OH number: 331 mg KOH/g

T_{g}=−15° C.

GPC Mₙ=3700, M_{w}=104 000 (eluent: DMAc)

Analysis of the hyperbranched polymers according to the invention:

The polymers were analyzed by gel permeation chromatography using a refractometer as detector. Tetrahydrofuran (THF) or dimethylacetamide (DMAc) was used as mobile phase, and polymethyl methacrylate (PMMA) was used as standard for determining the molecular weight.

The determination of the glass transition temperatures was carried out by means of differential scanning calorimetry (DSC), with the second heating curve being evaluated. The determination of the acid number and of the OH number was carried out in accordance with DIN 53240, Part 2.

Production of Polyurethane/Rubber Composites

The effect of hyperbranched polymer for improving the adhesion is made clear below for the example of composite materials comprising a polyurethane hot casting system and rubber plates. For this purpose, reaction mixtures were prepared from a polyesterol comprising adipic acid, 1,4-butanediol and ethylene glycol (OH number =55 mg KOH/g), diphenylmethane 4,4′-diisocyanate (4,4′-MDI) and 1,4-butanediol and also, if appropriate, the hyperbranched polymer (HP) as shown in table 1 and applied to rubber plates. As rubber plates, use was made of rubber elastomers from the class of acrylonitrile-butadiene rubbers (NBR) and polystyrene-butadienes (SBR). The surfaces of the vulcanized rubber plates were cleaned with ethanol before use.

TABLE 1

| | Comparison 1 | Example 2 |
|---|---|---|
| Polyesterol | 26.7 | 26.7 |
| 4,4′-MDI | 41.9 | 41.9 |
| 1,4-Butanediol | 4.7 | 4.7 |
| HP | — | 3.0 |

An isocyanate prepolymer was firstly prepared from the polyesterol and 4,4′-MDI in accordance with the amount shown in table 1. This prepolymer and butanediol (comparative examples 2 and 3) or prepolymer, butanediol and HP (examples 3 and 4) was subsequently in each case heated to 80° C. and mixed with one another. The reaction mixtures obtained in this way were introduced into an aluminum mold which had been preheated to 110° C. and comprised a rubber strip having dimensions of 4×10×0.1 cm on the bottom of the mold. The dimensions of the aluminum mold were 15×20×0.5 cm. After heating at 110° C. for 3 hours, the plates were removed from the mold and allowed to cool.

The tensile bond strength was measured by a method based on EN ISO 20 344 after storage at room temperature for 24 hours. The tensile bond strengths reported are means of six-fold determinations.

TABLE 2

| | | Tensile bond |
|---|---|---|
| | | strength |
| | Rubber | [N/mm] |
| Comparative | NBR | 4.1 |
| example 2 | | |
| Example 3 | NBR | 8.0 |
| Comparative | SBR | 1.3 |
| example 3 | | |
| Example 4 | SBR | 3.2 |

The mean of the tensile bond strengths of the PUR elastomer improves significantly on addition of the hyperbranched additive to the system. The adhesion increases both when using NBR and when using SBR.

1. A composite comprising at least one polyurethane and at least one further solid, with the polyurethane comprising at least one hyperbranched polymer, wherein the thickness of the polyurethane is 0.1 mm and greater.

2. The composite according to claim 1, wherein the hyperbranched polymer has a weight average molecular weight of greater than 500 g/mol and a degree of branching of greater than or equal to 0.05.

3. The composite according to claim 1 or 2, wherein the hyperbranched polymer is a hyperbranched polymer based on ethers, amines, esters, carbonates, amides, urethanes or ureas or the mixed forms ether-amines, ester-amides, amido-amines, ester-carbonates and urea-urethanes.

4. The composite according to any of claims 1 to 3, wherein the hyperbranched polymer is bound via functional groups to the solid at the interface of polyurethane and solid.

5. The composite according to claim 4, wherein the hyperbranched polymer is bound to the solid by covalent bonding or via interaction of the functional group with the solid.

6. The composite according to any of claims 1 to 5, wherein the hyperbranched polymer is a hyperbranched polyester d1) which is obtained by esterification of α,β-unsaturated carboxylic acids or derivatives thereof with polyfunctional alcohols.

7. The composite according to any of claims 1 to 6, wherein the hyperbranched polymer (c) is a hyperbranched polymer comprising hydrophobic units having more than 6 carbon atoms.

8. The composite according to claim 7, wherein a fatty acid radical or a fatty alcohol radical is comprised as hydrophobic unit.

9. The composite according to any of claims 1 to 7, wherein the hyperbranched polymer (c) is a hyperbranched polyester (c2) which is obtained by esterification of α,β-unsaturated carboxylic acids or derivatives thereof with polyfunctional alcohols, with the α,β-unsaturated carboxylic acids or derivatives thereof being hydrophobicized by means of a hydrophobicizing agent comprising at least one C—C double bond before or after the esterification.

10. The composite according to claim 9, wherein the hydrophobicizing agent is linear or branched polyisobutylene.

11. The composite according to any of claims 1 to 10, wherein the compound having at least two reactive hydrogen atoms (b) comprises at least 50% by weight, based on the total weight of the component (b), of a polyesterol and the hyperbranched polymer (c) comprises at least 5% by weight, based on the total weight of the component (c), of a hyperbranched polyester (c1).

12. The composite according to any of claims 1 to 10, wherein the at least one compound having at least two reactive hydrogen atoms (b) comprises at least 50% by weight, based on the total weight of the component (b), of a polyetherol and the hyperbranched polymer (c) comprises at least 10% by weight, based on the total weight of the component (c), of a hyperbranched polyester (c2).

13. The composite according to any of claims 1 to 12, wherein the hyperbranched polymer is incorporated by covalent bonding into the polymer matrix of the polyurethane.

14. The composite according to any of claims 1 to 13, wherein the hyperbranched polymer is comprised in the polyurethane in an amount of from 0.001 to 50% by weight, based on the total weight of the polyurethane.

15. The composite according to any of claims 1 to 14, wherein the polyurethane is a massive polyurethane or a foam based on polyurethane.

16. The composite according to claim 15, wherein the foam is a flexible foam, a semirigid foam, a rigid foam or an integral foam.

17. The composite according to any of claims 1 to 16, wherein the solid is a further polymer.

18. The composite according to claim 17, wherein the solid is a vulcanized rubber mixture based on natural rubber, butadiene rubber, styrene-butadiene rubber, isoprene rubber, acrylonitrile-butadiene rubber, chloroprene rubber, isobutene-isoprene rubber or mixtures comprising a plurality of these types of rubber or mixtures comprising one or more types of rubber and thermoplastic polymers such as styrene-comprising thermoplastics or polyethylene or polypropylene or thermoplastic elastomers based on styrene-butadiene-styrene or styrene-isoprene-styrene block copolymers or thermoplastic polyurethane.

19. The composite according to any of claims 1 to 16, wherein the solid is a metal.

20. The composite according to any of claims 1 to 16, wherein the solid is a textile material.

21. The composite according to any of claims 1 to 16, wherein the solid is a filler.

22. A process for producing a composite according to any of claims 1 to 20, wherein
a) organic and/or modified polyisocyanates are mixed with
b) at least one relatively high molecular weight compound having at least two reactive hydrogen atoms,
c) hyperbranched polymers and
d) if appropriate low molecular weight chain extenders and/or crosslinkers,
e) catalysts,
f) if appropriate blowing agents and
g) if appropriate other additives, and the mixture is applied to the solid together with which the composite is to be formed.

23. A process for producing a composite according to any of claims 1 to 20, wherein thermoplastic polyurethane is homogenized with hyperbranched polymer and the mixture is subsequently applied to a solid together with which the composite is to be formed.

24. The process according to claim 22 or 23, wherein the solid is chemically and/or physically pretreated before application of the polyurethane.

25. A process for producing a composite according to claim 21, wherein
a) organic and/or modified polyisocyanates are mixed with
b) at least one relatively high molecular weight compound having at least two reactive hydrogen atoms,
c) hyperbranched polymers and
d) if appropriate low molecular weight chain extenders and/or crosslinkers,
e) catalysts,
f) if appropriate blowing agents and
g) other additives comprising fillers.

26. A process for producing a composite according to claim 21, wherein thermoplastic polyurethane is homogenized with hyperbranched polymer and fillers.

27. The use of hyperbranched polymer as constituent of a polyurethane for improving the adhesion between the polyurethane and a further solid, wherein the thickness of the polyurethane is 0.1 mm and greater.
